(19) United States
(12) Patent Application Publication
(10) Pub. No.: US 2009/0269546 A9
(43) Pub. Date: Oct. 29, 2009

(54) POSITIVE RETENTION FLOOR MAT SYSTEMS

(75) Inventor: William G. Alford, Canton, OH (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 12/146,221

(22) Filed: Jun. 25, 2008

Related U.S. Application Data
(60) Provisional application No. 60/937,199, filed on Jun. 26, 2007.

(51) Int. Cl. B60N 3/04

(52) U.S. Cl. 428/99; 296/97.23; 16/4; 24/662

(57) ABSTRACT

Embodiments of the present invention may take the form of a positive retention floor mat system.

### CROSS-REFERENCE TO RELATED APPLICATION

This application claims the benefit of U.S. provisional application Ser. No. 60/937,199 filed Jun. 26, 2007, which is incorporated herein by reference in its entirety.

### BACKGROUND

### Related Field

Embodiments of the present invention relate to positive retention floor mat systems.

### SUMMARY

Embodiments of the present invention may take the form of a positive retention floor mat system.

In an embodiment, a positive retention floor mat system includes an attachment knob that is configured to be attached to a vehicle floor mat and an anchoring part that is configured to be attached to interior floor of a vehicle. The anchoring part is configured to be releasably attached to the attachment knob to secure the floor mat to the vehicle floor.

In another embodiment, a positive retention floor mat system includes a grommet assembly that is configured to be attached to a vehicle floor mat. The grommet assembly has portions that form a keyhole therein. The floor mat system also includes a grommet interface part that has a bottom section for attaching the grommet interface part to vehicle floor. The grommet interface part has a key portion for releasably securing the floor mat to vehicle floor. The key portion has an inner cylinder and a top outer cylinder. The key portion is configured for insertion within the keyhole of the grommet assembly.

In another embodiment, a positive retention floor mat system includes a floor mat, an upper snap connected to the floor mat, and a lower snap that is configured for connection to an interior floor of a vehicle. The lower snap is configured to mate with the upper snap to releasably attach the upper snap to the lower snap.

### DRAWINGS

FIGS. 1-21 show positive retention floor mat systems according to embodiments of the present invention.

### DETAILED DESCRIPTION

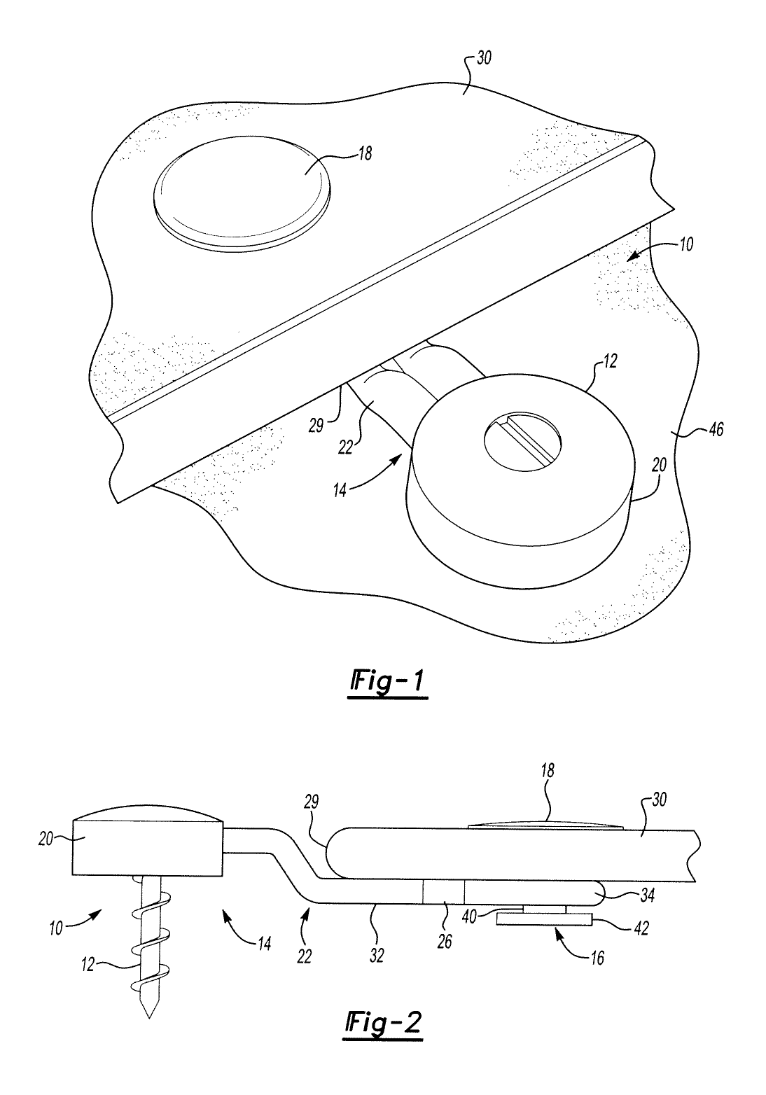

Referring to FIGS. 1-4, a positive retention floor mat system is illustrated therein and designated generally at 10. The system 10 includes a fastener 12, a shock cord assembly 14, an attachment knob 16, and a cap 18.

In the embodiment of FIGS. 1-4, the fastener 12 is a nylon auger screw; however, it should be understood that the fastener 12 may be made of any other suitable material, such as plastic or metal, without falling beyond the spirit and scope of the present invention. Furthermore, the fastener 12 could be an auger screw as shown in FIGS. 1-4, or it could have other configurations. For example, the fastener 12 could be a standard screw, rivet, or nail. The fastener 12 preferably has a length of about 38 mm (1.5 in.); however, the fastener 12 could have any other suitable length without falling beyond the spirit and scope of the present invention.

The shock cord assembly 14 includes an anchor portion 20 connected to a cord portion 22. The anchor portion 20 may be comprised of a plastic, such as acrylonitrile butadiene styrene (ABS), or any other suitable material, such as metal.

The anchor portion 20 preferably has a cylindrical shape, with a diameter of about 30 mm (1.18 in.) and a height of about 13 mm (0.5 in.); however, it should be understood that the anchor portion 20 could have another other suitable shape without falling beyond the spirit and scope of the present invention. For example, the anchor portion 20 could be formed as part of the cord portion 22 and have a configuration similar to that of the cord portion 22, which will be described in further detail below. An aperture 24 is formed within the anchor portion 20. The aperture 24 is preferably cylindrical as shown in FIG. 4 and extends through the height of the anchor portion 20. The aperture 24 is configured to receive the fastener 12, such that the fastener 12 extends through the aperture 24.

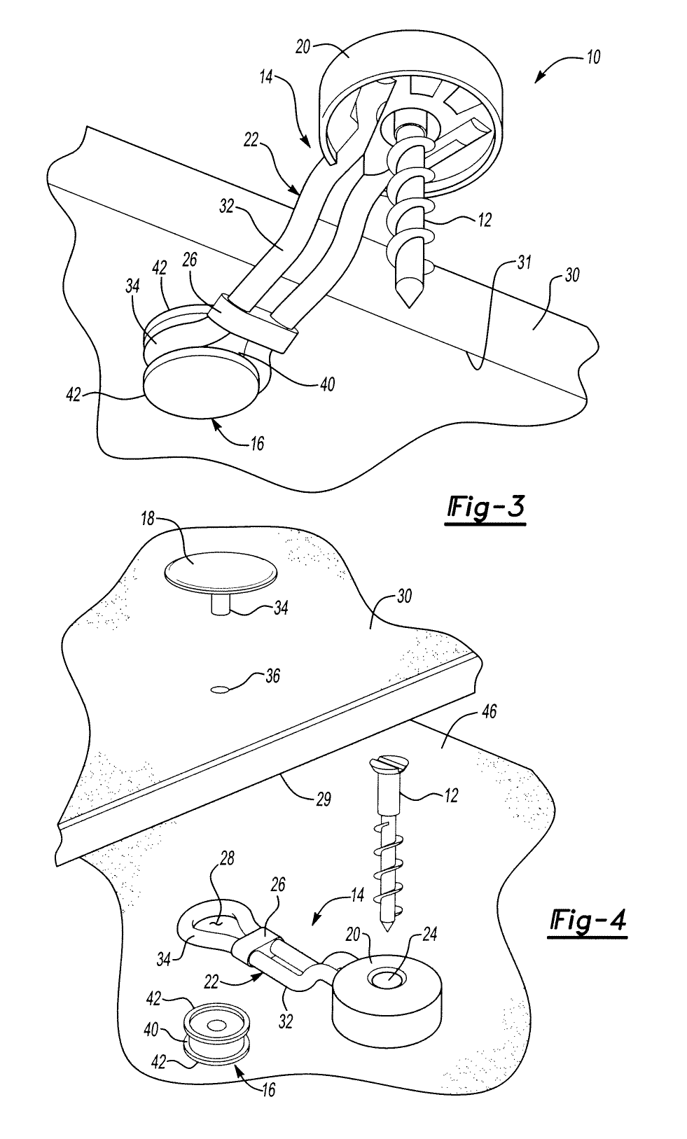

The shock cord assembly 14 also has a cord portion 22, which may be attached to the anchor portion 20 (as best shown in FIG. 3) or integrally formed with the anchor portion 20. The cord portion 22 is preferably formed of an elastic or elastomeric material, such that the cord portion 22 may be stretched around the attachment knob 16, which will be described in further detail below. Preferably, the cord portion 22 is formed of an elastomeric material covered with a fabric. Preferably, the cord portion 22 has a circular cross section with a diameter of about 5 mm (0.2 in.) and a cord length of about 63.5 mm (2.5 in.), although any other suitable dimensions could be used.

In FIGS. 1-4, a metal clip 26 is secured a round the cord portion 22 to clamp the cord portion together so that the cord portion 22 may be secured to the attachment knob 16. The metal clip 26 could be crimped or otherwise secured into place on the cord portion 22, or in the alternative, the metal clip 26 could be moveable along the cord portion 22 between an attached position and a detached position. More particularly, in the attached position, the metal clip 26 would secure that cord portion 22 to the attachment knob 16 by forming a loop 28 that would be sized to snugly surround the attachment knob 16. In the detached position, the metal clip 26 would be moved along the cord portion 22 such that the loop 28 would become larger, allowing the attachment knob 16 to be removed from the cord portion 22. The clip 26 is described as being metal; however, any other suitable material could alternatively be used.

It should be understood that the cord portion 22 could be provided without the metal clip 26, within the spirit and scope of the present invention. For example, the system 10 could be installed such that the cord portion 22 is stretched tightly, so that the cord portion 22 secures the knob assembly 16 without need of a metal clip 26. In such a configuration, an equal and opposite system 10 should be provided on an opposite side of the floor mat 30. Alternatively, the cord portion 22 could be formed together at a base portion 32, such that the loop 28 is formed only in an end portion 34. In such a configuration, the loop 28 could be stretched around the knob attachment 16 to secure the cord portion 22 to the knob attachment 16. In yet another variation, the cord portion 22 could be tied to form the loop 28, such that the loop 28 is sized to snugly surround the attachment knob 16 in an attached position and stretched to release the loop 28 from the attachment knob 16 in a detached position.

The attachment knob 16 is held to the floor mat 30 via the cap 18. The cap 18 has a shaft portion 34 that extends through an aperture 36 in the floor mat 30. The shaft portion 34 is preferably attached to the knob portion via a press fit, although it is also contemplated that other methods of attachment could be used; for example, the shaft portion 34 could have screw threads and be screwed in to the knob attachment 16. In one embodiment, the shaft portion 34 could have barbs (not shown) to help facilitate the above-referenced dress fit. The cap 18 is preferably formed of plastic, and more preferably, the plastic is ABS or an equivalent material.

The cap 18 preferably has a circular shape with a diameter of about 25.4 mm (1 in.), although other shapes and dimensions could alternatively be used.

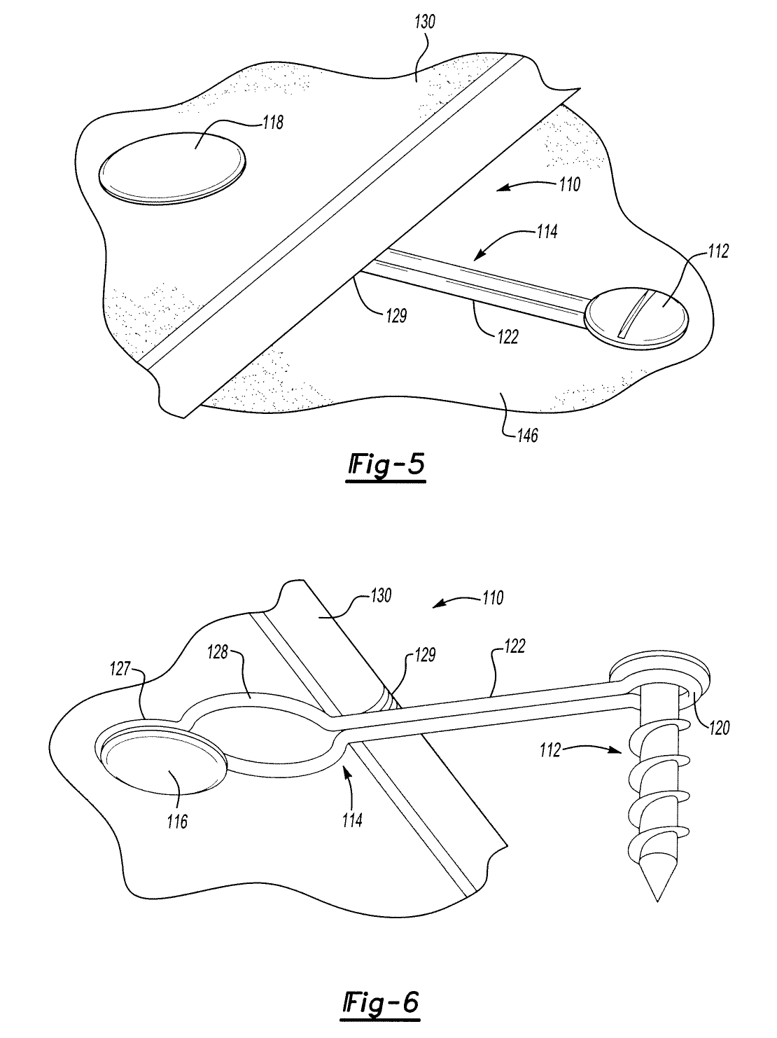

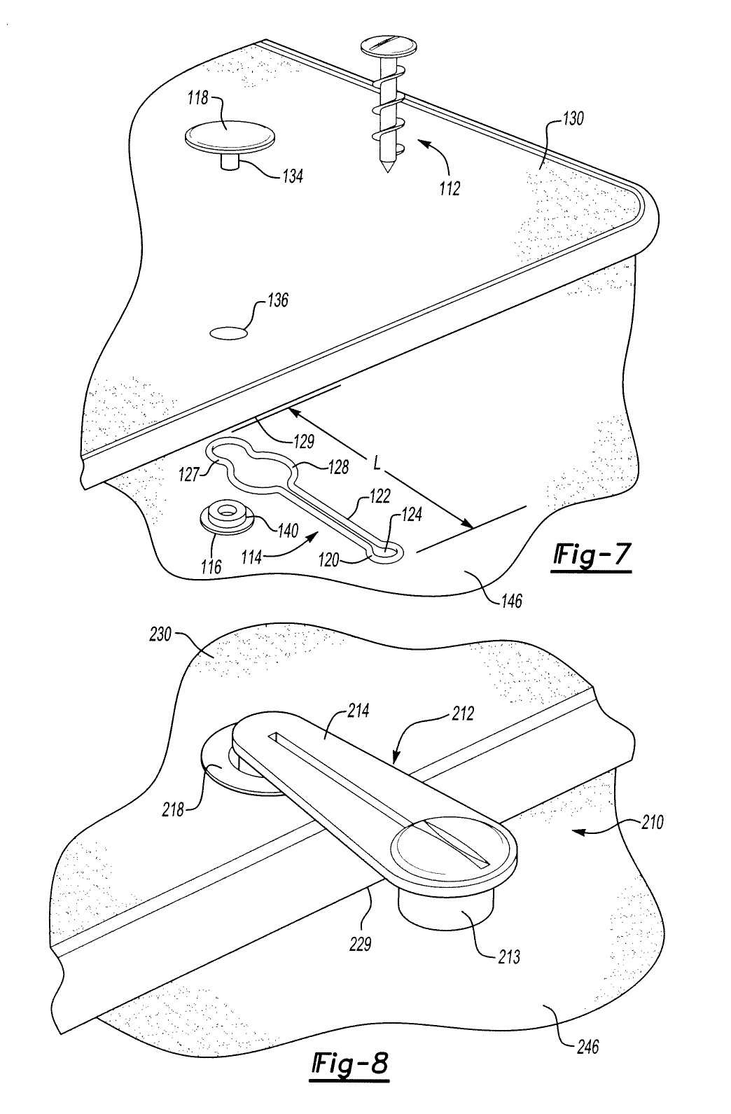

The attachment knob 16 is held by the cap 18 to the underside of the floor mat 30. The attachment knob 16 allows the cord portion 22 of the shock cord assembly 14 to be secured to the floor mat 30. To this end, the attachment knob 16 preferably has a spool-like shape having an inner cylinder 40 around which the cord portion 22 is secured. The inner cylinder 40 is connected to outer cylinders 42. In the attached position, the cord portion 22 is nestled between the outer cylinders 42. Alternatively, the attachment knob 16 could have just one outer cylinder 42 on the lower side of the inner cylinder 40, similar to the attachment knob 116 of FIGS. 5-7, which will be described in further detail below. The attachment knob 16 is preferably formed of a plastic, such as ABS. The preferable dimensions of the attachment knob 16 are as follows: the inner cylinder 40 has a diameter of about 10 mm (0.4 in.), the outer cylinders 42 have a diameter of about 17 mm (0.67 in.), and the height of the attachment knob 16 is about 11 mm (0.43 in.). It should be understood that other suitable dimensions could be used, in the alternative, without falling beyond the spirit and scope of the present invention.

The system 10 of FIGS. 1-4 operates to releasably hold the floor mat 30 to the vehicle floor 46. The shock cord assembly 14 is anchored to the vehicle floor 46 via the fastener 12, and the knob attachment 16 is secured to the floor mat 30 via the cap 18. The cord portion 22 of the shock cord assembly 14 may be attached to the attachment knob 16 when a user desires to have the floor mat 30 secured to the vehicle floor 46 and detached when a user desires to remove the floor mat 30 from the vehicle floor 46.

The system 10 may be installed by a motor vehicle manufacturer, a motor vehicle dealer, or an end user. To install the system 10, the installer should create an aperture 36 within the floor mat 30 near the side 29 of the floor mat 30 and secure the attachment knob 16 to the floor mat 30 by inserting the cap 18 through the aperture 36 to press fit the cap 18 to the attachment knob 16. The installer should secure the cord portion 22 of the shock cord assembly 14 to the attachment knob 16. The floor mat 30 should be placed in the desired location on the vehicle floor 46; the preferred location for the anchor portion 20 can then be established. The installer should place a pin (not shown), or a nail, through the aperture 24 of the anchor portion 20, and the anchor portion 20 and the floor mat 30 should be moved away from the pin. It will be recognized that other location marking means maybe employed instead of a pin, such as markings, stickers, a finger tip, etc. The shock cord assembly 14 should be removed from the floor mat 30 and the anchor portion 20 should be placed back over the pin. Then, the pin should be removed and the fastener 12 should be inserted through the aperture of the anchor portion 20 without moving the anchor portion 20 away from the vehicle floor 46. The fastener 12 should be attached to the vehicle floor 46 by screwing the fastener 12 into the floor 46, or by otherwise securing the fastener 12 to the floor 46. The attachment knob 16 can then be reattached to the cord portion 22 if it is desired to have the floor mat 30 attached to the vehicle floor 46.

Referring now to FIGS. 5-7, another positive retention floor mat system is illustrated therein and designated generally at 110. The system 110 includes a fastener 112, a loop 114, an attachment knob 116, and a cap 118.

In the embodiment of FIGS. 5-7, similar to the embodiment of FIGS. 1-4, the fastener 112 is a nylon auger screw; however, it should be understood that the fastener 112 may be made of any other suitable material, such as a plastic or metal, without falling beyond the spirit and scope of the present invention. Furthermore, the fastener 112 could be an auger screw as shown in FIGS. 5-7, or it could have other configurations. For example, the fastener 112 could be a standard screw, rivet, or a nail. The fastener 112 preferably has a length of about 25.4 mm (1.0 in.); however, the fastener 112 may have any other suitable length without falling beyond the spirit and scope of the present invention.

The loop 114 may be an anodized wire loop, a plastic loop, a wire loop covered with a plastic, elastomeric, or fabric coating, or it may be formed of any other suitable material. The loop preferably has an anchor portion 120, a straight section 122, an installation opening 128, and a holder section 127. Preferred dimensions on the loop 114 are as follows: the loop 114h as a length L of about 97 mm (3.8 in.), the diameter of the installation opening 128 is about 19.4 mm (0.76 in.), the diameter of the holder section 127 is about 10 mm (0.4 in.), and the diameter of a cross-section of the loop 114 is about 1.5 mm (0.06 in.). It should be understood that any suitable dimensions could be used without falling beyond the spirit and scope of the present invention.

The attachment knob 116 is held to the floor mat 130 via the cap 118. The cap 118 has a shaft portion 134 that extends through an aperture 136 in the floor mat 130. The shaft portion 134 is preferably attached to the attachment knob 116 via a press fit, although it is also contemplated that other methods of attachment could be used; for example, the shaft portion 134 could have screw threads and be screwed into the knob attachment 116. In one embodiment, the shaft portion 134 could have barbs (not shown) to help facilitate the above-referenced dress fit. The cap 118 is preferably formed of plastic, and more preferably, the plastic is ABS or an equivalent material. The cap 118 preferably has a circular shape with a diameter of about 25.4 mm (1 in.), although other shapes and dimensions could alternatively be used.

The attachment knob 116 is held by the cap 118 to the underside of the floor mat 130. The attachment knob provides a structure to which the loop 114 can be attached, To this end, the attachment knob 116 preferably has an inner cylinder 140 around which the holder section 127 of the loop 114 may be secured. The attachment knob 116 has a lip portion 142 formed at the bottom of the inner cylinder 140 to prevent the holder section 127 from sliding off the bottom of the attachment knob 116. Alternatively, the attachment knob 116 could have top and bottom lip portions 142, similar to the outer cylinders 42 described in connection with FIGS. 1-4. The attachment knob 116 is preferably formed of a plastic, such as ABS.

The preferable dimensions of the attachment knob 116 are as follows: the inner cylinder 140 has a diameter of about 10 mm (0.4 in), the lip portion 142 has diameter of about 17 mm (0.67 in.), and the height of the attachment knob 116 is about 11 mm (0.43 in). It should be understood that any other suitable dimensions could alternatively be used without falling beyond the spirit and scope of the present invention.

The system 110 of FIGS. 5-7 operates to releasably hold the floor mat 130 to the vehicle floor. 146. The loop 114 is anchored to the vehicle floor 146 via the fastener 112, and the attachment knob 116 is secured to the floor mat 130 via the cap 118. The loop 114 may be attached to the attachment knob 116 when a user desires to have the floor mat 130 secured to the vehicle floor 146 and detached when a user desires to remove the floor mat 130 from the vehicle floor 146. To attach the loop 114 to the attachment knob 116, a user should insert the attachment knob 116 through the installation opening 128 and slide attachment knob 116 into the holder section 127 of the loop 114 to secure the attachment knob 116 to the loop 114.

The system 110 may be installed by a motor vehicle manufacturer, a motor vehicle dealer, or an end user. To install the system 110, the installer should create the aperture 136 within the floor mat 130 near the side 129 of the floor mat 130 and secure the attachment knob 116 to the floor mat 130 by inserting the cap 118 through the aperture 136 to press fit the cap 118 to the attachment knob 116. The installer should secure the loop 114 to the attachment knob 116. The floor mat 130 should be placed in the desired location on the vehicle floor 146; the preferred location for the anchor portion 120 can then be established. The installer should place a pin (not shown) through the aperture 124 of the anchor portion 120 and insert the pin into the vehicle floor 146. The loop 114 and the floor mat 130 should then be moved away from the pin. It will be recognized that other location marking means maybe employed instead of a pin, such as markings, stickers, a fingertip, etc. The loop 114 should be removed from the floor mat 130 and the anchor portion 120 should be placed back over the pin. Then, the pin should be removed and the fastener 112 should be inserted through the aperture 124 of the anchor portion 120 without moving the anchor portion 120 away from the vehicle floor 146. The fastener 112 should be attached to the vehicle floor 146 by screwing the fastener 112 into the floor 146, or by otherwise securing the fastener 112 to the floor 146. The attachment knob 116 can then be reattached to the loop 114 if it is desired to have the floor mat 130 attached to the vehicle floor.

An alternative method of installing the system 110 includes securing the loop 114 to a seat frame of the vehicle instead of the vehicle floor 146. In this embodiment, it may be desirable to secure the attachment knob 116 and cap 118 to the floor mat 130 at a side of the floor mat 130 that faces the rear of the vehicle.

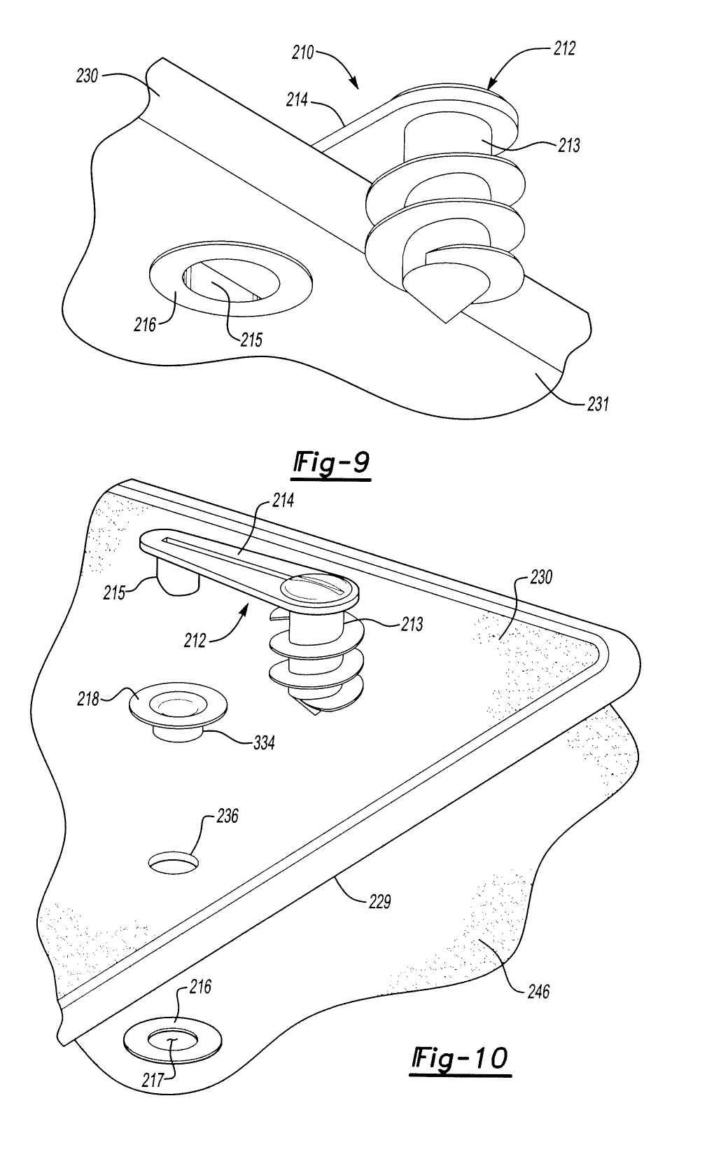

Referring now to FIGS. 8-12, another positive retention floor mat system is illustrated therein and designated generally at 210. The system 210 includes a clip 212, an attachment ring 216, and a grommet 218.

In the embodiment of FIGS. 8.-12, the clip 212 is a flexible plastic clip, preferable formed of ABS or an equivalent thereof. The clip 212 has an auger portion 213 for securing the clip 212 to the floor 246 of a motor vehicle. The auger portion 213 is connected to an arm 214, which is further connected to a grommet interface tab 215. Preferably, the auger portion 213, arm 214, and grommet interface tab 215 are formed as one piece, and these collectively make up the clip 212. The preferred dimensions of the clip 212 are as follows: the arm 214 has a length of about 50.8 mm (2 in.), the grommet interface tab 215h as a height of about 12 (0.5 in.), and the auger portion 213 has a height of about 38 mm (1.5 in.); however, one of ordinary skill should understand that a clip 212 of any suitable dimensions could be used without falling beyond the spirit and scope of the present invention.

The grommet 218 is secured to the floor mat 230 via the attachment ring 216. The grommet 218 has an inner cylindrical portion 234 that extends through an aperture 236 in the floor mat 230. The attachment ring 216 is placed on the underside 231 of the floor mat 230 to secure the attachment ring 216 to the cylindrical portion 234. The attachment ring 216 is secured to the cylindrical portion by virtue of a press fit, crimping, or any other suitable method. The attachment ring 216 could be a washer formed of metal, plastic, elastomeric material, or any other suitable material. The attachment ring 216 could have inner barbs (not shown) help secure the attachment ring 216 to the cylindrical portion 234. The grommet 218 could be formed of metal, plastic, or any other suitable material. The inner diameter of the cylindrical portion 234 is sized to receive grommet interface tab 215, such that cylindrical portion 234 and grommet interface tab may be removably secured via a press fit.

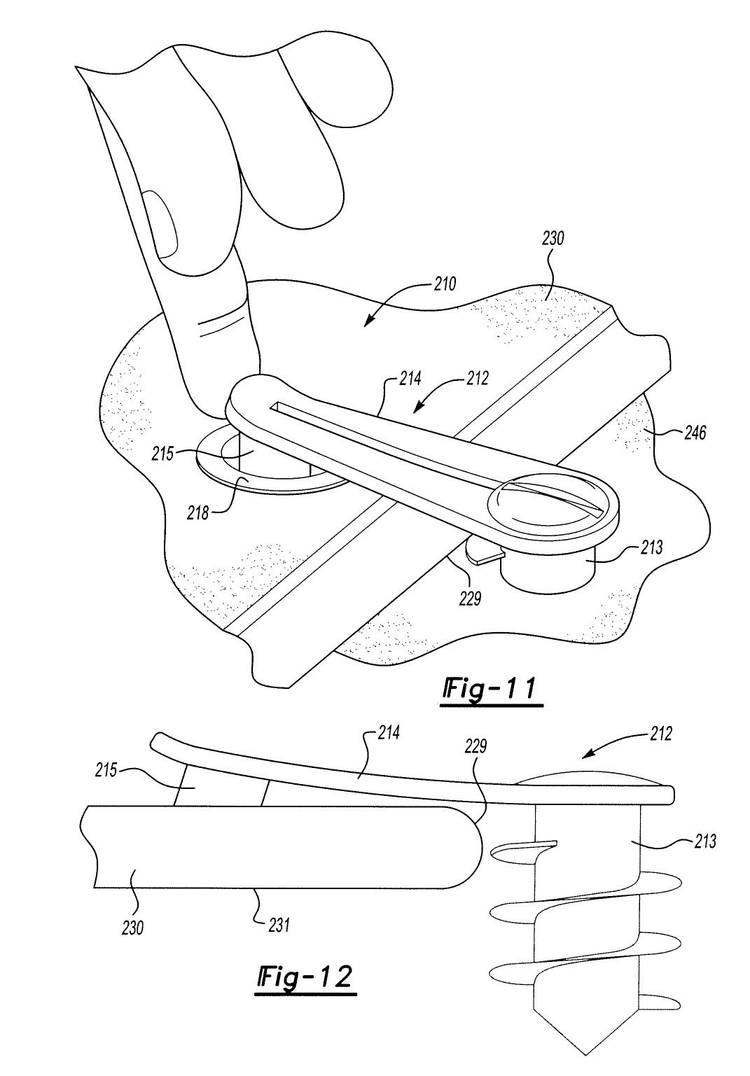

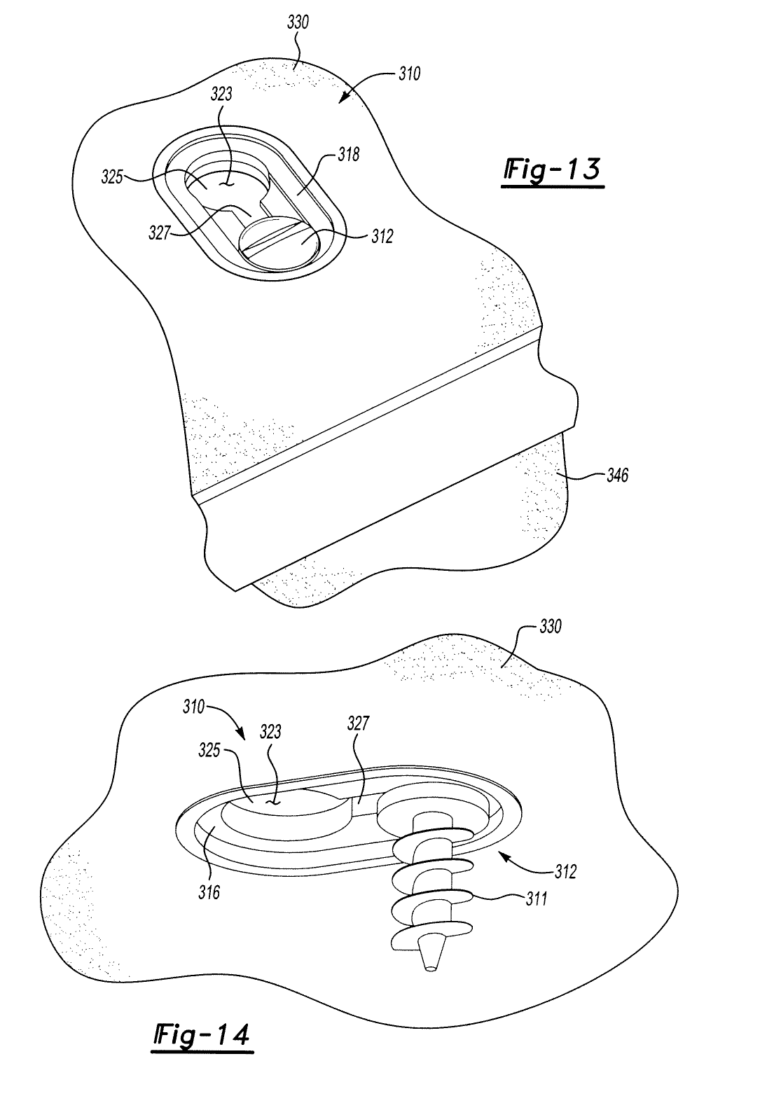

The system 210 of FIGS. 8-12 operates to releasably hold the floor mat 230 to the vehicle floor 246. The clip 212 is anchored to the vehicle floor 246 via the auger portion 213, and the grommet 218 is secured to the floor mat 230 via the attachment ring 216. The grommet interface tab 215 of the clip 212 may be press fit into the grommet 218 when a user desires to have the floor mat 230 secured to the vehicle floor 246 and pulled out of the grommet 218 when a user desires to remove the floor mat 230 from the vehicle floor 246, as best shown in FIGS. 11-12.

The system 210 may be installed by a motor vehicle manufacturer, a motor vehicle dealer, or an end user. To install the system 210, the installer should create an aperture 236 within the floor mat 230 near a side 229 of the floor mat 230 and secure the grommet 218 to the floor mat 230 by inserting the cylindrical portion 234 through the aperture 236 of the floor mat 230 and the aperture 217 of the attachment ring 216 to press fit the grommet 218 in the aperture 217 of the attachment ring 216. The installer should secure the grommet interface tab 215 of the clip 212 into the grommet 218. The floor mat 230 should be placed in the desired location on the vehicle floor 246; the preferred location for inserting the auger portion 213 of the clip 212 can then be established. The installer should press the auger portion 213 down to make a mark (not shown) in the vehicle floor 246. It will be recognized that other location marking means may be employed instead of a mark, such as a pin, stickers, a fingertip, etc. The clip 212 should be removed from the floor mat 230 and the auger portion 213 should be screwed to the vehicle floor 246 at the location of the mark. The grommet interface tab 215 can then be reinserted into the grommet 218 if it is desired to secure the floor mat 230 to the vehicle floor 246.

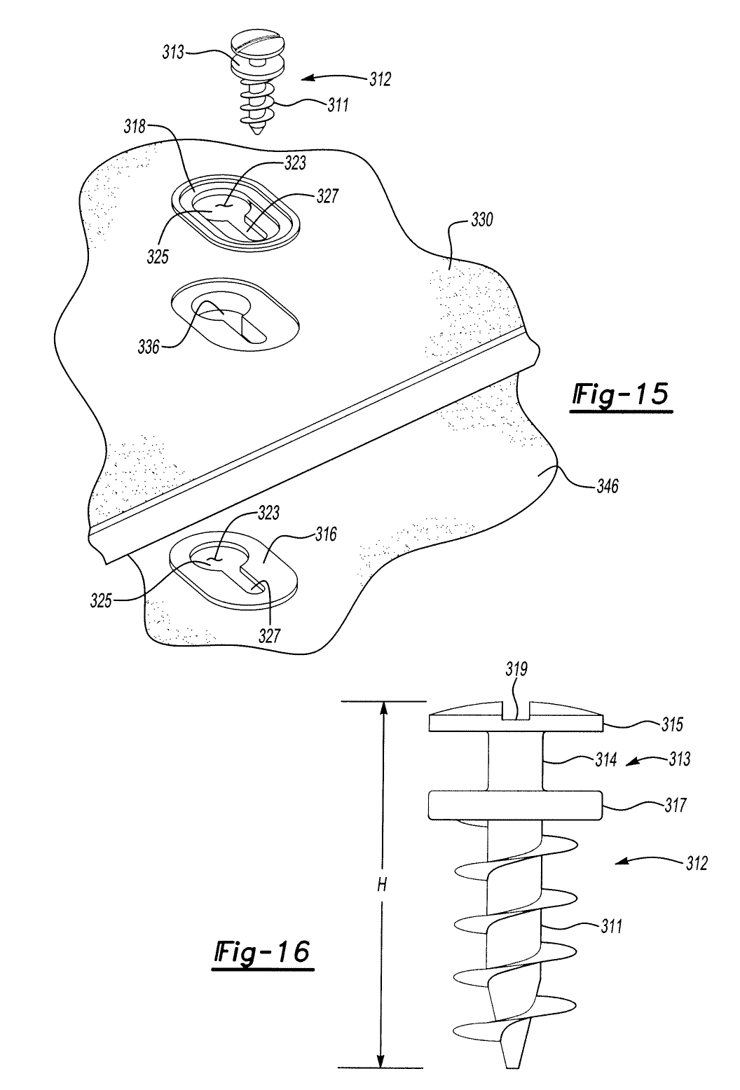

Referring now to FIGS. 13-16, another positive retention floor mat system is illustrated therein and designated generally at 310. The system 310 includes a grommet interface part 312, a grommet top 318, and a grommet bottom 316. The grommet top 318 and grommet bottom 316 combine to form a grommet assembly that attaches to a vehicle floor mat 330. It should be understood the grommet assembly need not be limited to a grommet top 318 and a grommet bottom 316; it is contemplated that the grommet assembly could comprises multiple parts or one single part. In an embodiment wherein the grommet assembly is one single part, it could be attached to the floor mat 330 by inserting it into an aperture within the floor mat 330.

In the embodiment of FIGS. 13-16, the grommet interface part 312 is a nylon interface auger, having a bottom portion 311 that resembles an auger screw; however, it should be understood that the grommet interface part 312 could be made of any other suitable material, such as plastic or metal, without falling beyond the spirit and scope of the present invention. Furthermore, the bottom portion 311 could resemble an auger screw as shown in FIGS. 13-16, or it could have other configurations. For example, the bottom portion 311 could resemble a standard screw, rivet, or a nail. The grommet interface part 312 also has a key portion 313, disposed at one end of the bottom portion 311. The key portion 313 has a spool-like shape, including an inner cylinder 314, and outer cylinders 315, 317 disposed on each side of the inner cylinder 314. The top outer cylinder 315 preferably has a slot 319 for receiving the head of screwdriver during installation or removal. The preferred dimensions of the grommet interface part 312 are as follows: the entire height H is about 25 mm, the height of the inner cylinder 314 is about 6.3 mm, and the diameter of the outer cylinders 315, 317 is about 12 mm; however, the grommet interface part 312 could have any other suitable dimensions without falling beyond the spirit and scope of the present invention.

The grommet top 318 and grommet bottom 316 each have portions forming a keyhole 323 therein. The portions forming keyholes 323 preferably include portions forming a round section 325 connected to portions forming a slot 327. The grommet top 316 and grommet top 318 are secured to each other via a press fit, a crimp, or other suitable means, with the floor mat 230 being sandwiched therebetween. In one embodiment, the grommet top 318 and/or grommet bottom 316 could have barbs (not shown) to help facilitate the above-referenced dress fit. The grommet top 318 and grommet bottom 316 are preferably formed of plastic, such as ABS or an equivalent material, or metal. The preferred dimensions for the grommet top 318 and grommet bottom 316 are as follows: each has a length of about 38 mm (1.5 mm), a width of about 25.4 mm (1 in.), a round section diameter of about 14 mm (0.55 in.), and a slot 327 length of about 15 mm (0.6 in.).

The system 310 of FIGS. 13-17 operates to releasably hold the floor mat 330 to the vehicle floor 346. The grommet interface part 312 is anchored to the vehicle floor 346 via the bottom portion 311. Top grommet 318 and bottom grommet 316 are secured together with the floor mat 330 secured between them. The floor mat 330 may be slid on or off of the grommet interface part 312 through the keyhole 323 formed by the grommets 316, 318. When a user desires to secure the floor mat 330 to the vehicle floor 346, he or she should place the round section 325 of the keyhole 323 over the key portion 313 of the grommet interface part 312. Next, the user should slide the floor mat 330 such that the key portion 313 slides along the slot 327 of the keyhole 323. The floor mat 330 will then be secured to the vehicle floor 346. To remove the floor mat 330, the user should slide the floor mat 330 such that the key portion 313 of the grommet interface part 312 slides along the slot in a direction toward the round section 325. When the key portion 313 is in the center of the round section 325 of the keyhole 323, the floor mat 330 can be pulled upward and removed from the vehicle floor 346.

The system 310 may be installed by a motor vehicle manufacturer, a motor vehicle dealer, or an end user. To install the system 310, the installer should create the aperture 336 shaped similarly to the keyhole 323 within the floor mat 330 near the side 329 of the floor mat 330. The installer should then secure the grommets 316, 318 to each other with the floor mat 330 sandwiched therebetween, using a suitable method such as a press fit or crimp. The keyholes 323 and the aperture 336 should be lined up when attaching the grommets 316, 318 together, so that a through-hole is present through the floor mat 330 and grommets 316, 318. A cap (not shown) could optionally be attached atop the grommet top 318 for a cleaner look.

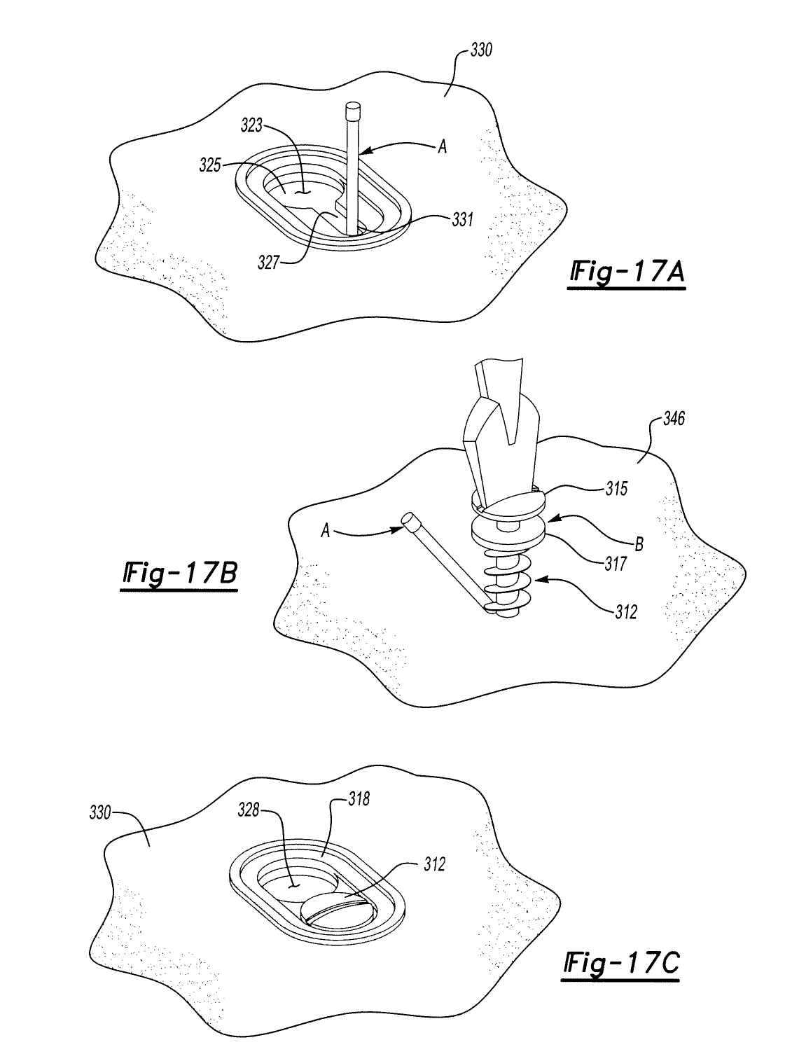

With reference to FIG. 17, the installer should place the floor mat 330 on the vehicle 346 in the desired location. The installer should then place a pin A, which may be a small pin or nail, through the distal end 331 of the slot 327 into the vehicle floor 346. It will be recognized that other location marking means may be employed instead of a pin, such as markings, stickers, a fingertip, etc. The installer should then carefully remove the floor mat 330, leaving the pin A in the vehicle floor 46. Then, the bottom portion 311 of the grommet interface part 312 should be placed at the location wherein the pin A is, and the grommet interface part 312 can then be screwed in to the floor 346 or otherwise secured to the floor 346. The bottom portion 311 should be completely inserted into the floor 346, such that the bottom outer cylinder 317 slightly depresses the carpet on the vehicle floor 346. The floor mat 330 may then be attached to the vehicle floor 346 as described above, if desired.

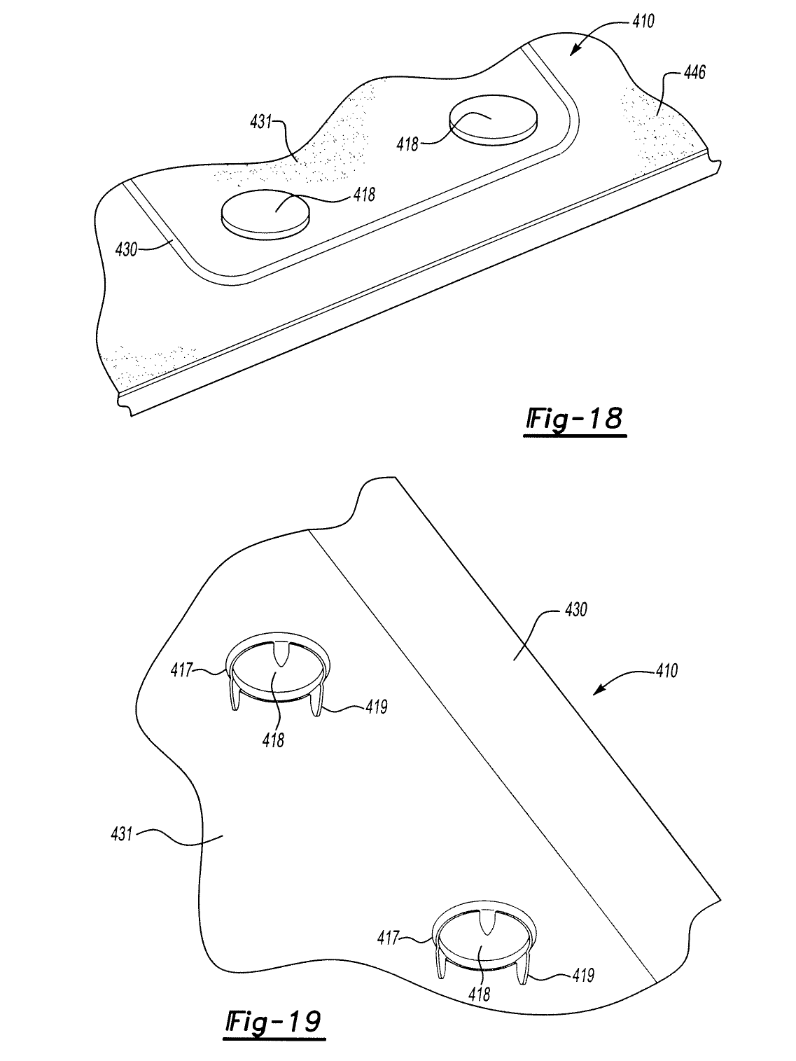

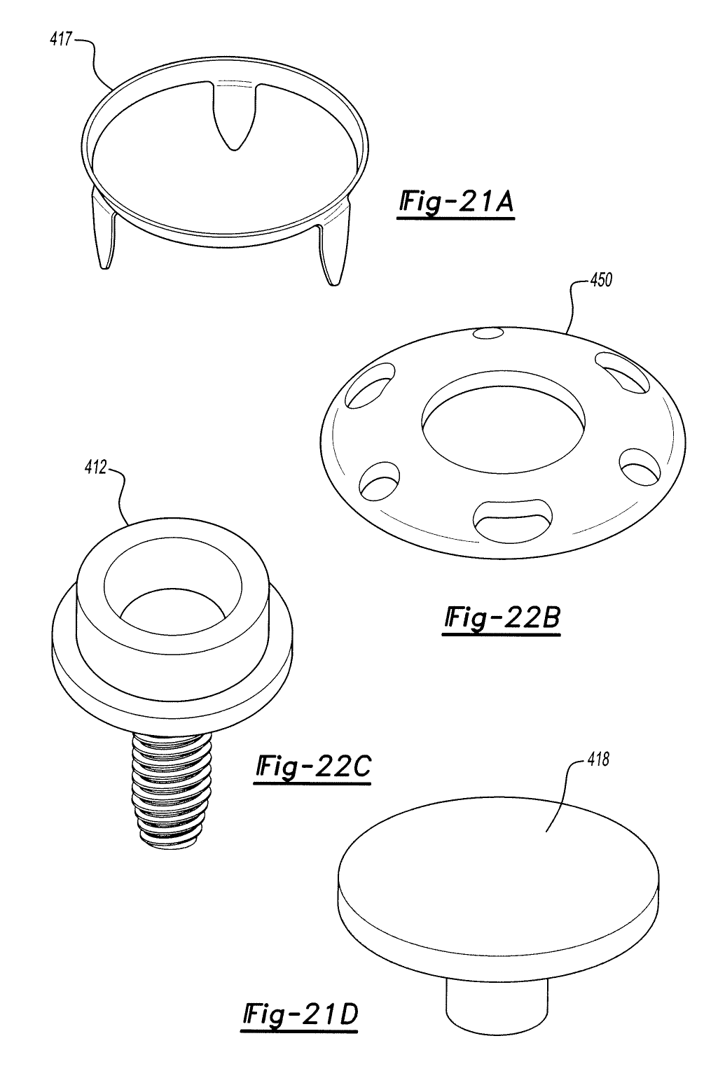

Referring now to FIGS. 18-21, another positive retention floor mat system is illustrated therein and designated generally at 410. The system 410 includes snaps, such as the Veltex Carpet Snaps shown in FIG. 21, to secure a floor mat 430 to vehicle floor 446; however, it should be understood that any suitable snaps could be used without falling beyond the spirit and scope of the present invention.

In the embodiment of FIGS. 18-21, a ring 417 is secured to the floor mat 430 via a cap 418. The ring 417 and cap 418 are fit together via a press fit or crimp, through an aperture 436 in the vehicle floor mat 430. The ring 417 has barbs 419 that protrude from the bottom side 431 of the floor mat 430. In the alternative, standard snaps could be attached to the bottom side 431 of the floor mat 430 such that no cap 418 or other component is visible from the top side 432 of the floor mat 430.

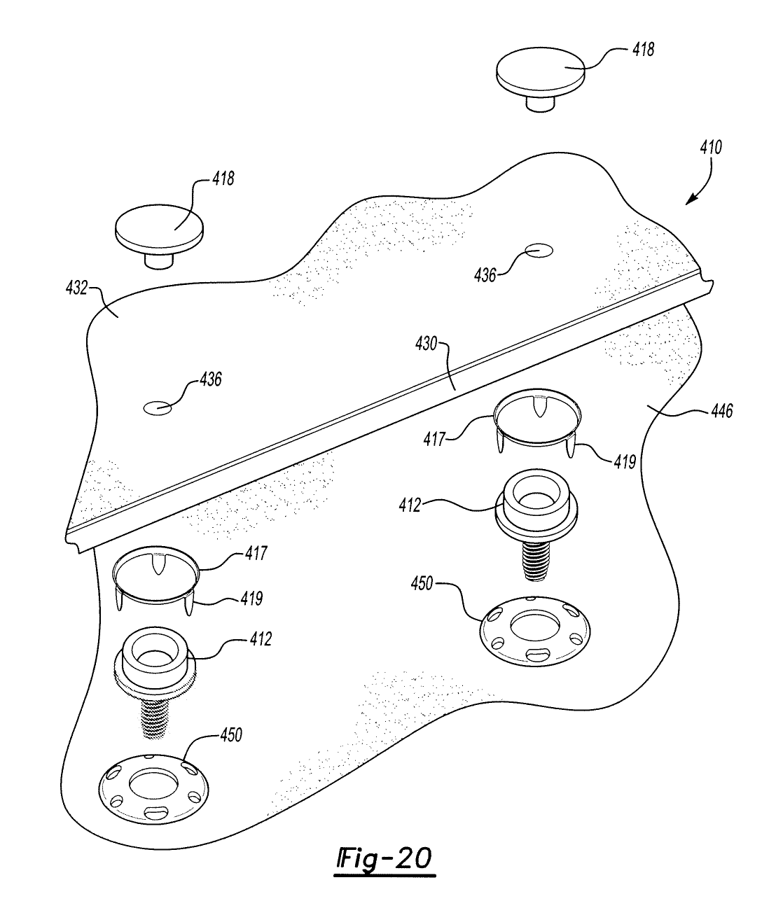

A socket 450 for receiving the barbs 419 of the ring 417 is attached to the vehicle floor 446. The socket 450 may be attached to the floor 446 via a fastener 112, such as a screw, as shown in FIGS. 20-21, or the socket 450 may be attached to the floor 446 by any other suitable means, such as by sewing the socket 450 to the floor 446.

The system 410 of FIGS. 18-21 operates to releasably hold the floor mat 430 to the vehicle floor 446. Upper snaps, such as the caps 418 and rings 417 of FIGS. 18-21, are secured to the floor mat 430, and lower snaps, such as the sockets 450 and fasteners 412 of FIGS. 18-21, are secured to the vehicle floor 446. When a user desires to have the floor mat 430 attached to the vehicle floor 446, the barbs 419 of the rings 417 may be inserted into the sockets 450. When the user desires to remove the floor mat 430 from the vehicle floor 430, the user should simply pull up on the floor mat 430 to pull the barbs 419 out of the sockets 450.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention.

What is claimed is:

1. A positive retention floor mat system comprising:
an attachment knob configured to be attached to a vehicle floor mat;
an anchoring part configured to be attached to interior floor of a vehicle, the anchoring part being configured to be releasably attached to the attachment knob to secure the floor mat to the vehicle floor.

2. A positive retention floor mat system comprising:
a grommet assembly configured to be attached to a vehicle floor mat, the grommet assembly having portions forming a keyhole therein; and
a grommet interface part having a bottom section for attaching the grommet interface part to vehicle floor, and a key portion for releasably securing the floor mat to vehicle floor, the key portion having an inner cylinder and a top outer cylinder, the key portion being configured to be inserted within the keyhole of the grommet assembly.

3. A positive retention floor mat system comprising:
a floor mat;
an upper snap connected to the floor mat;
a lower snap configured to be connected to interior floor of a vehicle, the lower snap configured to mate with the upper snap to releasably attach the upper snap to the lower snap.
